(19) United States
(12) Patent Application Publication
(10) Pub. No.: US 2004/0076266 A1
(43) Pub. Date: Apr. 22, 2004

(54) Xdsl modem that can be operated in the remote diagnosis mode and corresponding maintenance system

(76) Inventor: Hans-Werner Rudolf, Saverne (FR)

Correspondence Address: MORRISON & FOERSTER LLP, 1650 TYSONS BOULEVARD, SUITE 300, MCLEAN, VA, 22102, US

(21) Appl. No.: 10/333,987

(22) PCT Filed: Jul. 5, 2001
(86) PCT No.: PCT/DE01/02490

(30) Foreign Application Priority Data
Jul. 27, 2000 (DE) 10036689.9

(51) Int. Cl. H04M 3/08; H04M 11/00

(52) U.S. Cl. 379/1.03; 379/93.01

(57) ABSTRACT

The invention relates to an xDSL modem that can be operated in the remote diagnosis mode and to a corresponding maintanance system according to which the xDSL modem (2) comprises, in addition to a transceiver device (3) for transmitting/receiving data in a predetermined transmission format a failure profile detection device (4) for detection a failure profile and a failure profile transmission device (5, 3) for transmitting the detected failure profile to a maintenance installation. The invention provides an inexpensive means for carrying out the initial start-up as well as an error diagnosis of failure with a subscriber.

The present invention refers to an xDSL modem capable of remote diagnosis as well as an associated servicing system, and in particular an xDSL modem that substantially simplifies the installation and start-up operation. xDSL modems and the respective transmission formats enjoy more and more popularity as of late because of the ability to obtain a substantially higher data throughput of up to 8 Mbits/s on traditional two-wire circuits or copper wires than have been utilized until now by traditional transmission processes. The best-known xDSL transmission formats are now ADSL (asymmetrical digital subscriber lines), SDSL (symmetrical digital subscriber lines), UDSL/G.Lite (universal digital subscriber lines), HDSL (high-bit-rate digital subscriber lines) and VDSL (very high-bit-rate digital subscriber lines).

In contrast to ISDN (integrated services digital network), the bandwidth in xDSL transmission formats is not limited to 64 kbit/s but has for example a multiple of that data throughput, the increased data throughput resulting essentially by multiplying the number of modulated carriers in the frequency range. However, using the higher frequency bands on a two-wire circuit has the disadvantage that the transmission quality in the higher frequency bands especially on long-distance two-wire circuits decreases substantially, resulting in a limitation of the transmission capacity because of attenuation and mutual interference.

When installing and/or starting up operation of such an xDSL transmission line it is therefore necessary, in addition to an adaptive adjustment of the respective transmission systems to the two-wire circuit during the training phase, to exactly determine the quality and evaluate the transmission line in order to assure a quality transmission.

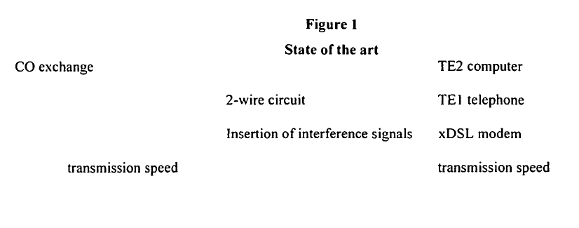

FIG. 1 shows a simplified illustration of a traditional xDSL transmission system during the start-up operation. According to FIG. 1, a new customer would connect for example a telephone as customer terminal TE1 and a computer as customer terminal TE2 via an xDSL modem M to a two-wire circuit 1. The two-wire circuit 1 leads directly to a central office CO or similar exchange location or facility. In order to implement the xDSL transmission, an xDSL modem card or circuit card (not shown) is installed in the central office CO for this customer connection. This is followed by an automatic mutual matching of the xDSL circuit card and the xDSL modem M to the respective circumstances of the two-wire circuit 1, whereby capacitive circuit overlays, reflections of stub lines, maladjustments etc. are automatically compensated via echo cancellations procedures and other adaptive procedures. The service personnel WP are then able to switch various test loops both at the central office side and the customer side in order to monitor the proper functioning of the transmission line and to subsequently record the bit error rate as well as the signal/noise ratio for example during the training phase of the xDSL modem M. It is for example possible to record the quality of the bandwidth of such a transmission line by measuring for example the transmission speed via a measuring device MG. The necessary measurements are taken at the central office side, resulting in a very precise determination of quality (for example for a later fee calculation) of the xDSL transmission that is optimally possible.

However, the extremely high cost of such a determination of quality or start-up operation of an xDSL modem or xDSL transmission system is a disadvantage, mainly due to travel by the service personnel WP to the customer and the on-site measurements performed.

It is therefore the purpose of the invention to create an xDSL modem capable of remote diagnosis and an associated servicing system, eliminating the sending of service personnel to the customer and thereby substantially reducing the cost to the service provider of a first installation.

The invention also has the purpose to facilitate cost-effective remote error diagnosis at the customer after the start-up.

The invention solves these tasks with regard to the xDSL modem capable of remote diagnosis by way of the characteristics of Claim 1, and with regard to the servicing system by way of the characteristics of Claim 9.

The xDSL modem automatically measures the qualitative data of the two-wire circuit especially by using an interference profile recording device to record the interference profile on the two-wire circuit and an interference profile transmission device to transmit the recorded interference profile in the xDSL modem, without the need for service personnel to travel to and carry out such measurements at the customer's location. The costs for the installation and start-up operation can thereby be substantially reduced.

A transmission/reception device of the xDSL modem preferably includes at least one digital signal processor, with the interference profile recording device and/or the interference profile transmission device implementing the at least one signal processor through a suitable design of that processor. In this way the recording and transmission of the customer-side interference profile can be implemented by this digital signal processor that is already integrated into the xDSL modem, further lowering the costs of the xDSL modem capable of remote diagnosis.

Depending on the mode selection data transmitted over the two-wire circuit, a particular transmission format can selectively be remote-adjusted by the central office side to the particular interference circumstances at the customer through the use of an additional mode selection device to select a predetermined xDSL transmission format in the xDSL modem capable of remote diagnosis, making it possible to cost-effectively select and implement the optimal transmission parameters at any time and for any kind of interference.

Preferably for example a central office has for this purpose an appropriate xDSL modem unit with the necessary transmission/reception device and the necessary interference profile recording device, where an additional interference profile decoding device decodes the interference profile of the customer transmitted via the two-wire circuit, and an additional analysis device analyzes the decoded interference profile and the interference profile recorded on the same line at the central office. By using the analysis results of the signal processor away from the central office and the processor at the central office one obtains at no additional cost a so-called “finger print” of the transmission line after the start-up operation.

Preferably, by using an additional mode control device, a predetermined xDSL transmission format can be preset on the central office side, and in addition mode selection data can be generated for the remote setting of the customer-side modem and transmitted via the two-wire circuit. Servicing and optimization work can thereby be carried out very cost-effectively on both modems. Moreover, the presence of the customer for such servicing work is no longer required, further substantially improving efficiency.

The other ancillary claims characterize other advantageous embodiments of the invention.

The invention is described below in more detail by way of an example of an embodiment, referring to the illustrations.

These show:

FIG. 1 a simplified presentation of a traditional xDSL transmission system showing the start-up operation;

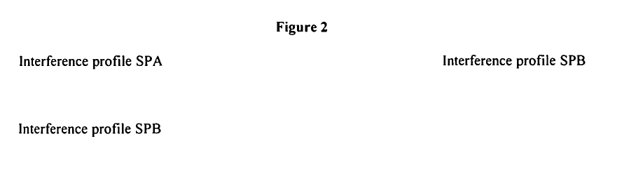

FIG. 2 a simplified diagram of the servicing system according to the invention;

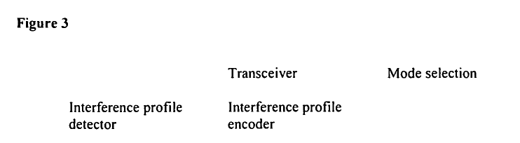

FIG. 3 a simplified diagram of a customer installation with the xDSL modem capable of remote diagnosis according to the invention;

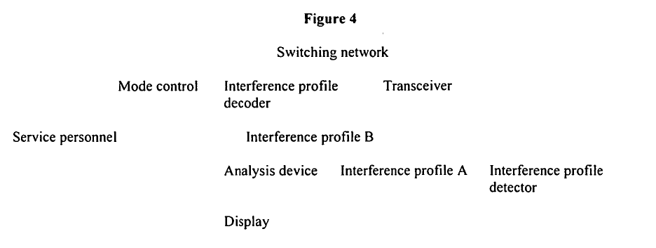

FIG. 4 a simplified diagram of a servicing installation according to the invention;

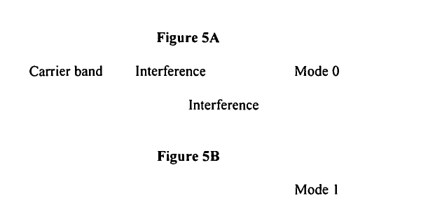

FIGS. 5A and 5B simplified frequency spectra of transmission formats for adjustment to a first interference of the narrow-band type; and

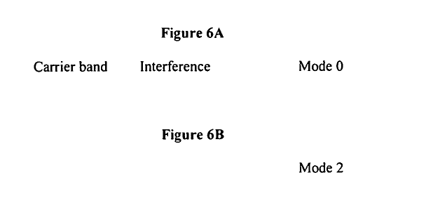

FIGS. 6A and 6B simplified frequency spectra of transmission formats for adjustment to a second interference of the broadband type.

FIG. 2 shows a simplified diagram of a servicing system according to the invention. In it a servicing point A is connected via a two-wire circuit 1 to a customer B capable of remote diagnosis.

Preferably servicing point A is located in the central office of a telecommunications service provider, with the reference LC referring to a line card with the respective xDSL modem interface. On the customer side the reference CPE refers to a customer installation including at least one xDSL modem capable of remote diagnosis and the associated customer terminals. Such customer terminals may be for example a telephone to implement voice connection or a computer to implement data and/or voice connection.

According to FIG. 2 the customer premise equipment CPE has the possibility to collect and record on its own an interference profile SPB in the two-wire circuit 1 on the customer side and to transmit it via a channel of the xDSL transmission line to the servicing installation LC. By the same token the servicing installation LC has the possibility to collect and record an interference profile SPA on the two-wire circuit on the servicing installation side, and in the process can also output the interference profile SPB of the customer premise equipment transmitted in the predetermined channel. As a result both an interference profile SPA and an interference profile SPB are available on the side of the servicing installation LC without the need for service personnel to travel to and carry out transmission-specific measurements at the location of customer B.

To be more precise, the only thing that is needed for implementing an xDSL transmission line is for a customer to order an xDSL modem capable of remote diagnosis from his respective service provider, and for the service provider to send the respective modem for example via courier service. In this case the customer receives the xDSL modem capable of remote diagnosis for example initially at no cost for a predetermined period of time and connects the xDSL modem capable of remote diagnosis to the available two-wire circuit. On the side of the customer terminal the xDSL modem capable of remote diagnosis can for example be connected to a computer via a USB interface or installed directly in it. Alternatively the xDSL modem capable of remote diagnosis can for example have an analog or digital telephone connection through which it is connected to an analog or digital telephone. The type and number of interfaces are not limited here, making it possible to use all other known or future interfaces.

After connecting the xDSL modem capable of remote diagnosis the customer calls for example his service provider and asks for a so-called test session during which a connection is established between the servicing installation LC and the customer installation CPE or the xDSL modem capable of remote diagnosis contained in it. Here the customer installation CPE can be configured in such a way that it transmits for example one or several tones within the transmission band at predetermined amplitudes, it being possible to measure the attenuation of the two-wire circuit 1 at the frequencies in the transmission band or carrier band on the side of the servicing installation LC. Preferably this spectrum is recorded with a spectrum analyzer on the side of the servicing installation LC, resulting in a first interference profile SPA.

On the other hand the customer installation CPE is preferably configured in such a way that it also functions as a spectrum analyzer and that the frequency spectrum of the interferences on the customer side and the noise can also be recorded. Such a spectrum or interference profile SPB can provide information on the signal/noise ratio as well as the various types of interference sources in the customer installation CPE. The interference profile SPB is then transmitted via the two-wire circuit 1 to the servicing installation LC and analyzed, making it possible to make a clear distinction between interference within and outside of the building of customer B. Service personnel can therefore carry out an in-depth remote diagnosis of possible interference sources without the need for on-site measurements at customer B and can thereby facilitate an active or passive improvement of the transmission performance. Passive improvement in this context means for example an instruction to customer B to turn off sources of interference, e.g. a hair drier or vacuum cleaner in the household. An active improvement of the transmission performance on the other hand is a selective matching of transmission formats to the sources of interference that exist in the household of customer B. This results in an optimization of an xDSL transmission line depending on the respective internal and external sources of interference.

FIG. 3 shows a simplified diagram of the customer installation CPE such as might be used by customer B. The customer installation CPE consists essentially of an xDSL modem 2 capable of remote diagnosis, a telephone as customer terminal TEl and a computer as customer terminal TE2. The customer terminal TE2 may for example be connected via a USB interface or another interface or may be built into the PC. By contrast the customer terminal TEl may be connected via an analog or digital interface to the xDSL modem capable of remote diagnosis. In principle it is also possible to connect additional customer terminals to the modem 2.

The xDSL modem 2 capable of remote diagnosis has essentially a transmission/receiving device or a transceiver 3 for transmitting/receiving voice and/or data in the predetermined xDSL transmission format fed into it by the respective customer terminals TEl and TE2. To carry out its remote diagnosis function, modem 2 has an interference profile recording device 4 to record the interference profile SPD shown in FIG. 2 and an interference profile encoder 5 to encode the recorded interference profile SPB in a transmittable data format. Together with the transceiver and/or the transmission/receiving device 3 the interference profile encoder 5 acts as an interference profile transmission device to transmit the recorded interference profile SPB.

Normally the transmission/receiving device 3 has at least one digital signal processor DSP. A particular advantage of the present invention, however, consists in programming the digital signal processor in such a way that in a certain operating function (e.g. test session) it implements the interference profile recording device 4 and/or the interference profile encoding device 5. In this way the recording, encoding and transmission of a customer-side interference profile SPB can be realized in an especially cost-effective way in modem 2.

According to FIG. 3 the xDSL modem 2 capable of remote diagnosis can also have a mode selection device 6 for selecting a predetermined xDSL transmission format depending on mode selection data transmitted via the two-wire circuit 1. In this way mode selection data can be sent back to the xDSL modem capable of remote diagnosis on the basis of the interference profiles evaluated or analyzed in the servicing installation and the modem can be reset to a new operating mode. This allows for an optimal adjustment to the existing sources of interference.

FIGS. 5A and 5B show simplified frequency spectra of transmission formats to illustrate the way the mode selection device 6 functions.

According to FIG. 5A the xDSL modem 2 is first operated in mode 0, in which a multitude of carrier bands with constant carrier bandwidth TBB are arranged immediately next to each other in the frequency range. The carrier distance TBA is therefore ≧0. A source of interference on the customer side here generates an interference with a very-sharp frequency band in the second and fourth carrier bands. By recording and transmitting the respective interference profile SPB to the servicing installation, it is possible not only to instruct the customer to remove the interference source but also to carry out an active adjustment to the source of interference. To be more precise, after analyzing the interference profile SPB a mode selection record can be sent back to the xDSL modem 2 capable of remote diagnosis, which is received by the transmission/receiving device 3 and forwarded to the mode selection device 6. Depending on the information stored in the mode selection data, the transmission/receiving device 3 is then switched to a predetermined xDSL transmission format or mode 1 according to FIG. 5B in which the interferences are now outside of the carrier bands. According to FIG. 5B such a mode selection occurs for example by enlarging the carrier band distance TBA.

In similar fashion and according to FIGS. 6A and 6B an interference signal with relatively broad frequency range is eliminated. According to FIG. 6A the xDSL modem 2 capable of remote diagnosis is initially again in mode 0, where a multitude of carrier bands with a predetermined carrier band width TBB are arranged close to each other. However, contrary to FIGS. 5A and 5B a relatively broad noise signal is now overlaid as a disturbance, affecting a multitude of carrier bands. The respective interference profile SPB is again relayed to the servicing installation and analyzed, and the corresponding mode selection data are sent back to modem 2. After receiving the mode selection data the transmission/receiving device 3 is now switched by the mode selection device 6 according to FIG. 6B to a mode 2 or the corresponding xDSL transmission format in such a way that the result is again a reduction of interference in the frequency range. It is also possible to select a broadband transmission type with few or one single carrier.

According to FIGS. 5A through 6B the mode selection device 6 preferably changes a carrier bandwidth TBB and/or a carrier band distance TBA. Alternatively the mode selection device 6 may however also switch between the various usual transmission formats ADSL, UDSL, HDSL, VDSL, SDSL etc., resulting to a large extent in an adjustment or optimization of the transmission system to the particular line conditions.

FIG. 4 shows a simplified diagram of a servicing installation such as might be implemented for example as a line card LC in an exchange facility. According to FIG. 4 the servicing installation LC has an xDSL modem unit 7 for transmitting voice and/or data on the two-wire circuit 1. The xDSL modem unit 7 in turn has a transmission/receiving device 8 to transmit/receive data in a predetermined xDSL transmission format. The transmission/receiving device 8 however is now connected preferably with a switching network, not shown, of the exchange facility, in which the respective voice and data channels are coupled.

To record interference on the servicing installation side, the xDSL modem unit 7 optionally has an interference profile recording device 9 for recording the interference profile SPA on the two-wire circuit 1. The modem unit 7 has an interference profile decoding device 10 for decoding the interference profile SPB of the xDSL modem 2 capable of remote diagnosis that is transmitted via the two-wire circuit 1. An analysis device 11 serves to analyze both the recorded interference profile SPA and the decoded or transmitted interference profile SPB. The analysis device 11 is preferably implemented as a Fourier analysis device such as FFT (fast fourier transformation). Service personnel can examine the analysis results of the analysis device 11 for example via a display device 12 and according to experience select a mode control 13 to optimize the transmission line. However, the mode control 13 can also be selected directly via the analysis device 11, facilitating an automatic adjustment or online optimization without further involvement of personnel.

As already described above, the mode control 13 generates on the one hand the mode selection data for the xDSL modem 2 capable of remote diagnosis and also a selection command to set a predetermined xDSL transmission format of the transmission/receiving device 8. The transmission/receiving device 8, the interference profile recording device 9 and the interference profile decoding device 10 in turn can be implemented in one or more digital signal processors.

This allows for a particularly cost-effective installation and start-up operation of an xDSL transmission line. It also makes it possible to carry out an optimal adjustment and remote diagnosis in a very cost-effective manner.

The invention was described above in terms of a customer connection for the customer installation CPE and an exchange facility for the servicing installation LC. However, it is not limited to that and rather comprises all other xDSL configurations in which a remote diagnosis via a two-wire circuit 1 is of advantage. In the exemplary embodiment described above the two-wire circuit 1 consists of a point-to-point connection. However, it is not limited to that and can also take the form of point-to-multiple point connections. In the same vein the present invention can also be used both for line-switched telecommunications networks and for packet-switched telecommunications networks.

The transmission/receiving device consists preferably of a digital signal processor. However, it may equally well consist of microprocessors or signal processors and microprocessors. The interferences mentioned above were stray effects, reflections and noise. By the same token couplings between veins and other interferences are also conceivable. The interference profiles are preferably encoded in frequency and amplitude values (e.g. QAM). However, they may also be encoded in other ways.

1. xDSL modem capable of remote diagnosis for the transmission of voice and/or data on a two-wire circuit (1) and for connection to at least one customer terminal (TE1, TE2) with
a transmission/receiving device (3) for sending/receiving data in a predetermined transmission format (mode 0);
characterized by
an interference profile recording device (4) for recording an interference profile (SPB) on the two-wire circuit (1);
and an interference profile transmission device (5,3) for transmitting the recorded interference profile (SPB).

2. xDSL modem capable of remote diagnosis according to claim 1,
characterized by the fact that the transmission/receiving device (3) has at least one digital signal processor (DSP) and that the interference profile recording device (4) and/or interference profile transmission device (5,3) is implemented by at least this one signal processor (DSP).

3. xDSL modem capable of remote diagnosis according to claim 1 or 2,
characterized by a mode selection device for selecting a predetermined transmission format depending on the mode selection data transmitted via a two-wire circuit.

4. xDSL modem capable of remote diagnosis according to claim 3,
characterized by the fact that the mode selection device (6) changes a carrier bandwidth (TBB) and/or a carrier distance (TBA) in the xDSL transmission format to select the predetermined transmission format.

5. xDSL modem capable of remote diagnosis according to one of the claims 1 to 4, characterized by the fact that the transmission format is a broadband xDSL transmission format, a traditional analog modem transmission format or an ISDN transmission format.

6. xDSL modem capable of remote diagnosis according to one of the claims 1 to 5, characterized by the fact that the transmission format is an ADSL, UDSL, HDSL, VDSL or SDSL transmission format.

7. xDSL modem capable of remote diagnosis according to claim 5 or 6,
characterized by the fact that the mode selection device (6) selects one of the xDSL, modem or ISDN transmission formats as predetermined transmission format.

8. xDSL modem capable of remote diagnosis according to one of the claims 1 to 7,
characterized by the fact that the interference profile recording device (4) includes an interference frequency spectrum.

9. xDSL modem capable of remote diagnosis according to one of the claims 3 to 8,
characterized by the fact that the mode selection data are transmitted via a predetermined channel in the transmission format.

10. xDSL modem capable of remote diagnosis according to one of the claims 1 to 9,
characterized by the fact that an optimization of the transmission on the two-wire circuit (1) occurs during a data transmission.

11. xDSL modem capable of remote diagnosis according to one of the claims 1 to 10,
characterized by the fact that line transmission properties are analyzed and monitored.

12. Servicing system for an xDSL transmission system with a customer installation (CPE) using an xDSL modem (2) capable of remote diagnosis according to one of the claims 1 to 8; a servicing installation (LC) to service the customer installation (CPE); and a two-wire circuit (1) to connect the customer installation (CPE) to the servicing installation (LC),
characterized by the fact that the servicing installation (LC) has an xDSL modem unit (7) for transmitting voice and/or data on the two-wire circuit (1), with a transmission/receiving device (8) for sending/receiving data in a predetermined transmission format (mode 0); an interference profile recording device (9) for recording an interference profile (SPA) on the two-wire circuit (1); an interference profile decoding device (10) for decoding an interference profile (SPB) transmitted via the two-wire circuit (1) and
an analysis device (11) for analyzing the recorded interference profile (SPA) and the decoded interference profile (SPD).

13. [sic] Servicing system according to claim 9,
characterized by a display device (12) for displaying an analysis result of the analysis device (11).

14. [sic] Servicing system according to claim 9 or 10,
characterized by a mode control device (13) for selecting a predetermined transmission format for the xDSL modem unit (7) and for generating the mode selection data for the xDSL modem 2 capable of remote diagnosis to be transmitted on the two-wire circuit (1).

15. [sic] Servicing system according to claim 11, characterized by the fact that the mode control device (13) is controlled by service personnel and/or by an analysis result of the analysis device (11).
